(19) United States
(12) Patent Application Publication
(10) Pub. No.: US 2015/0074368 A1
(43) Pub. Date: Mar. 12, 2015

(54) THIN PROVISIONING STORAGE DEVICES IN CONNECTION WITH SECURE DELETE OPERATIONS

(71) Applicant: International Business Machines Corporation, Armonk, NY (US)

(72) Inventors: Shah Mohammad Rezaul Islam, Tucson, AZ (US); Sandeep R. Patil, Pune (IN); Riyazahamad M. Shiraguppi, Maharashtra (IN); Gandhi Sivakumar, Victoria (AU); Matthew B. Trevathan, Roswell, GA (US)

(73) Assignee: International Business Machines Corporation, Armonk, NY (US)

(21) Appl. No.: 14/019,596

(22) Filed: Sep. 6, 2013

(51) Int. Cl. G06F 3/06

(52) U.S. Cl. CPC G06F 3/0652; G06F 3/0604; G06F 3/0671
USPC 711/166

(57) ABSTRACT

A method for improving thin provisioning storage devices in connection with secure delete operations is provided. The method may include receiving at a physical storage device a first indicator to initiate writing a secure delete pattern to a plurality of physical storage locations. The secure delete pattern is written to a plurality of allocated physical storage locations based on the received first indicator. When a second indicator is set, the end of the secure delete pattern is reached. The thin provisioning storage device, upon receiving the second indicator, securely erases the plurality of storage device metadata regions where the mapping of virtual storage locations to allocated physical storage locations is stored. Requests to write a secure delete pattern for virtual storage locations without corresponding allocated physical storage locations are ignored.

### FIELD

The present disclosure relates generally to the field of data storage management, and more particularly, to on-demand storage management.

### BACKGROUND

In a conventional storage provisioning model, also known as fat/thick provisioning (FP), storage space allocation may include both current and future needs, in anticipation of eventually using the allocation. As a result, the utilization rate may remain low, as large amounts of storage space are paid for but may never be used. For example, an application may allocate 10 gigabytes (GB) according to an estimated processing requirement. However, if the application uses only 6 GB of the allocation, then 40% of the storage remains unused and unavailable to other applications.

In thin provisioning (TP), however, instead of reserving all the physical blocks of storage that an application requests at once, physical blocks of storage are not assigned until the application tries to perform a first write operation on the given block. This allows for over provisioning of the available storage and maximum utilization of the storage assets. Since the OS already thinks it has all the physical storage assigned to it, then as the storage system actually uses the disk capacity there is no additional work to be done by the OS or administrator.

Secure Delete provides a software-based way of overwriting a residual representation of data, known in the art as data remanence, which remains on a storage device even after attempts have been made to remove or erase the data. However, an application operating in a TP environment may not be aware of whether a virtual storage block in its storage allocation has an associated physical storage block that needs a secure delete operation. Therefore, an application that attempts to manage the secure delete operation may erroneously skip allocated physical storage blocks. The thin provisioning device is not able to differentiate between normal write requests and write operations that include a secure delete pattern write, and may unnecessarily allocate a physical storage block to an unused virtual storage block.

If the TP device were able to differentiate between secure pattern delete write operations and normal write operations, then when an application performs secure delete to remedy data remanence on its allocated blocks, the TP device can avoid unnecessarily allocating and writing to physical storage blocks for unused virtual storage blocks.

### BRIEF SUMMARY

Among other things, a method and system for improving thin provisioning storage devices in connection with secure delete operations is provided. According to an embodiment of the invention, a method and system for improving thin provisioning storage devices in connection with secure delete operations may include receiving at a physical storage device a first indicator to write a secure delete pattern to a plurality of physical storage locations; writing the secure delete pattern to a plurality of allocated physical storage locations based on the received first indicator; and erasing a plurality of storage device metadata regions based on a second indicator, wherein the metadata regions map the plurality of allocated physical storage locations to a plurality of virtual storage locations.

In another embodiment of the invention, a computer program product for improving thin provisioning storage devices in connection with secure delete operations is provided. The computer program product may include a device driver program embodied on a computer readable storage medium. The device driver program may include code executable by a processor to perform a method that may include receiving at a physical storage device a first indicator to write a secure delete pattern to a plurality of physical storage locations; writing the secure delete pattern to a plurality of allocated physical storage locations based on the received first indicator; and erasing a plurality of storage device metadata regions based on a second indicator, wherein the metadata regions map the plurality of allocated physical storage locations to a plurality of virtual storage locations.

In another embodiment of the invention, a computer system for improving thin provisioning storage devices in connection with secure delete operations is provided. The computer system may include one or more processors, one or more computer-readable storage devices, and a plurality of program instructions stored on at least one of the one or more storage devices for execution by at least one of the one or more processors. The plurality of program instructions may include program instructions to receive at a physical storage device a first indicator to write a secure delete pattern to a plurality of physical storage locations; program instructions to write the secure delete pattern to a plurality of allocated physical storage locations based on the received first indicator; program instructions to differentiate the request to write the secure delete pattern from other write requests based on the first indicator; and program instructions to erase a plurality of storage device metadata regions based on a second indicator, wherein the metadata regions map the plurality of allocated physical storage locations to a plurality of virtual storage locations.

### BRIEF DESCRIPTION OF THE SEVERAL VIEWS OF THE DRAWING

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram of a computer system used in at least one exemplary embodiment of a method of improving thin provisioning storage devices in connection with secure delete operations;

FIG. 2 is a flow diagram of a method of improving thin provisioning storage devices in connection with secure delete operations, according to at one exemplary embodiment;

FIG. 3 is a schematic block diagram of hardware and software of the computer environment according to at least one exemplary embodiment of the method of FIG. 2.

### DETAILED DESCRIPTION

The following described exemplary embodiments improve thin provisioning storage devices in connection with secure delete operations.

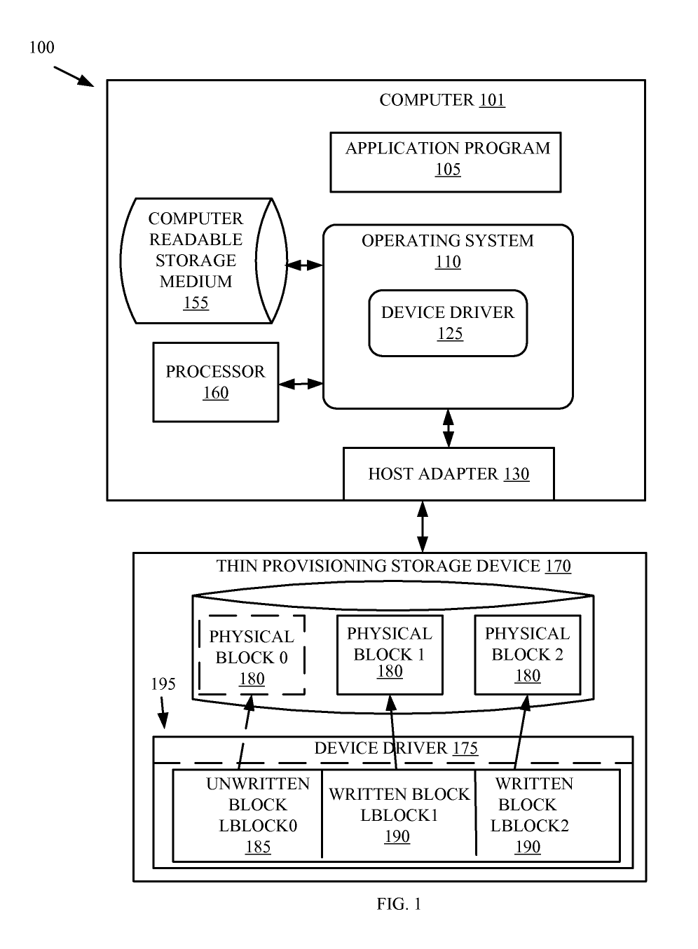

Referring to FIG. 1, a system 100 for improving thin provisioning storage devices in connection with secure delete operations is provided. The system 100 includes a device driver 125 within the computer 101. The device driver 125 may be stored on a computer readable storage device 155 of a computer 101, which includes a processor 160 for executing the instructions of a program, i.e., the device driver 125. The device driver 125 executes on the computer 101 and may be supplied with the operating system 110 to implement a protocol for an application program 105 to use in communicating with the thin provisioning storage device 170. The computer 101 may include one or more types of host adapter 130 implementations, including for example, SCSI or Fibre Channel through which the thin provisioning storage device 170 connects to the computer 101. A device driver 175 may be provided in one of several formats, including as a device driver, microcode, or firmware, to execute the program instructions of the method 100 within the thin provisioning storage device 170. The controller portion of the thin provisioning storage device 170, depicted as 195, may contain the virtualization layer which represents both the unwritten (185) blocks, and written (190) blocks of storage allocated to the application program 105. Until the application program 105 actually writes on allocated storage, the controller 195 tracks the storage block as allocated but unwritten (185). When an application program 105 actually writes on one of the allocated blocks of storage, then a corresponding physical block 180 is allocated on the storage medium of the thin provisioning storage device 170. The particular description in FIG. 1 is for illustrative purposes only; it should be understood that the invention is not limited to specific described embodiments, and any combination is contemplated to implement and practice the invention.

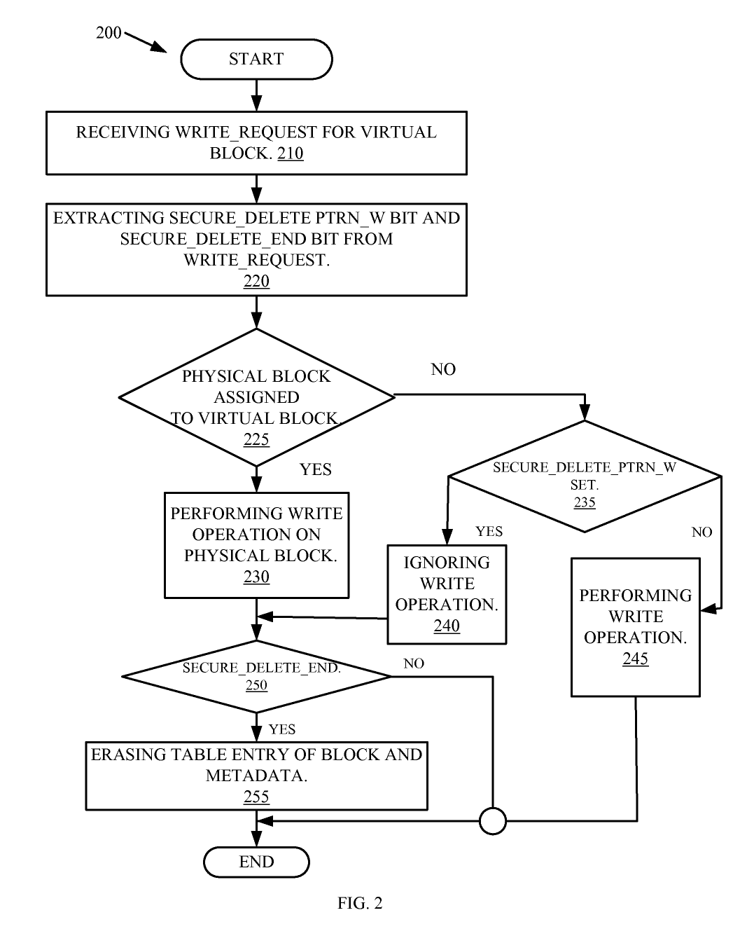

Referring now to FIG. 2, the reference numeral 200 generally designates a flow diagram illustrating a method of improving thin provisioning storage devices in connection with secure delete operations. A Secure Delete operation is a software-based method of writing one or more data patterns to a digital device, such as the thin provisioning device 170, such that all electronic data is completely destroyed, but the digital device remains available for future use. The Secure Delete operation is performed directly on the physical device, bypassing the virtual layer. Currently, a thin provisioning storage device 170 is not able to differentiate between a request to write a pattern for a secure delete and a normal write request. Therefore, during the first data pattern write of a secure delete operation, the thin provisioning device unnecessarily assigns new physical blocks corresponding to the previously unused virtual blocks (also referred to as logical blocks) resulting in redundant physical storage block allocations and write operations.

The following discussion uses an industry-standard SCSI Command Descriptor Block (CDB) and illustrates an exemplary embodiment of the method of the device driver 125 from an application program's point of view. However, other exemplary embodiments, such as a separate protocol channel such as Remote Procedure Call (RPC), or one or more new commands, may be used.

A component of the thin provisioning storage device 170, for example the device's controller, may track the virtual to physical mapping of storage blocks, similar to the following table:

TABLE 1

| Logical Block | Physical Block | Status |
|---|---|---|
| LBlock 0 | — | Allocated, UnWritten |
| LBlock 1 | PBlock 1 | Allocated, Written |
| LBlock 2 | PBlock 2 | Allocated, Written |
| LBlock 3 | — | Free |
| LBlock 4 | — | Free |
| LBlock 5 | — | Free |

Using a vendor-supplied utility, the application program 105 may query the thin provisioning storage device 170 to determine a list of virtual blocks allocated to the application program 105, here LBlock 0, LBlock 1, and LBlock 2.

In this example, a reserved bit in the CDB, for example bit “5” of byte “14”, is assigned a value indicating the start of a secure delete pattern write request, such as for example SECURE_DELETE_PTRN_W (SDPW). For each virtual block in the list that was returned to the application program 105, a write request is created specifying the pattern to use in this particular pass, and sent to the thin provisioning storage device 170. The processing continues for each of a plurality of write patterns until write requests have been sent to thin provisioning storage device 170 for all virtual blocks listed as allocated to the application program 105. When the application program 105 has created CDB write requests for each virtual block in the application program's 105 list, the application program 105 sets a reserved bit in the CDB, for example bit “6” of byte “14”, to a value indicating the end of a secure delete pattern write request, such as for example SECURE_DELETE_END (SDE).

At 210 the thin provisioning storage device 170 receives a CDB that the application program 105 created. The SDPW and SDE bits are extracted at 220 and interrogated to determine a type of processing request specified in the CDB. If at 225 a physical block is allocated to a virtual block then the operation specified in the CDB may proceed at 230, since the virtual to physical relationship has already been established. If at 250, the SDE bit is also set, then this is the final virtual block for which the application program 105 is requesting a secure delete operation. In that case, at 255 the thin provisioning storage device 170 also erases any metadata associated with the physical storage blocks that were allocated to the application program 105, along with the associated table entries, such as for example those shown in Table 1 previously.

However, if at 225 a physical block is not allocated to a virtual block, then the thin provisioning storage device 170 may distinguish between a pattern write, indicated by the SDPW bit set, and a normal write request. If at 235 the SDPW bit is set, but no physical block is allocated to the virtual block, then even though this is a request for a pattern write, at 240 the pattern write request is ignored. Processing continues at 250, where the setting of the SDE bit is checked, and the associated metadata may be erased if the SDE bit, indicating the last virtual block has been processed. By ignoring the pattern write request at 240, performance may be improved, since the processing cycles to allocate a physical block, write the pattern, then release the physical block are eliminated. However, the integrity of the secure delete process is maintained, and may be enhanced, since the metadata is erased along with the allocated physical storage blocks at the end of processing at 255.

If at 235 the SDPW bit is not set, then at 245 default legacy write processing is indicated. Therefore, a physical block 180 will be allocated for an allocated but unwritten virtual block 185, the write operation will occur.

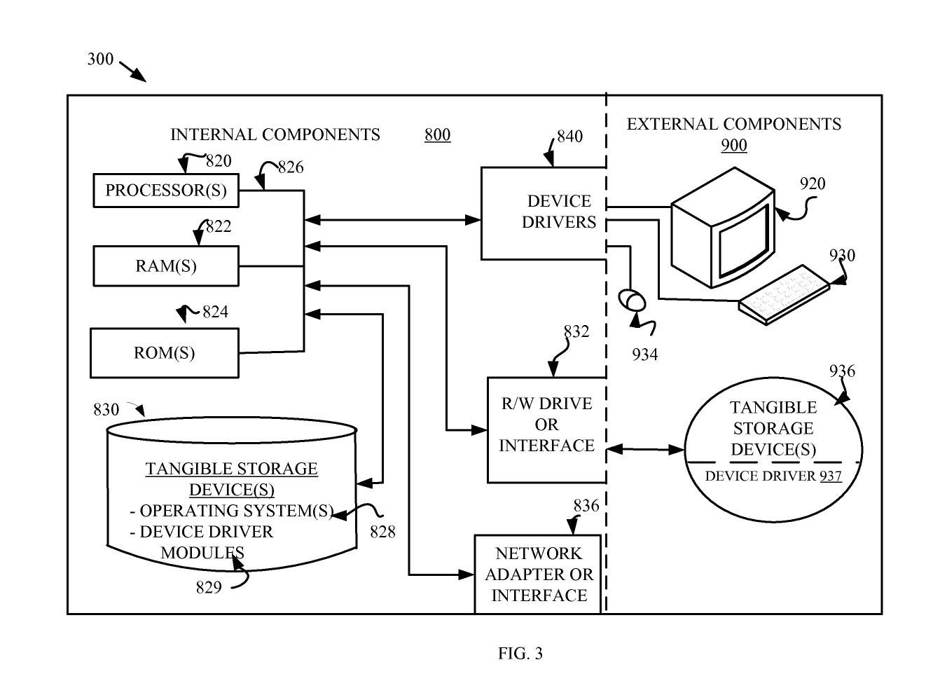

Referring now to FIG. 3, computing device 300 may include respective sets of internal components 800 and external components 900. Each of the sets of internal components 800 includes one or more processors 820; one or more computer-readable RAMs 822; one or more computer-readable ROMs 824 on one or more buses 826; one or more operating systems 828; one or more software applications (e.g., device driver modules 829) executing the method 200; and one or more computer-readable tangible storage devices 830. The one or more operating systems 828 and device driver modules 829 are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage devices 936 such as a thin provisioning storage device, CD-ROM, DVD, SSD, memory stick, magnetic tape, magnetic disk, optical disk or semiconductor storage device. The R/W drive or interface 832 may be used to load the device driver 937 firmware, software, or microcode to tangible storage device 936 to facilitate communication with components of computing device 300.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The device driver modules 829 and operating system 828 that are associated with computing device 300, can be downloaded to computing device 300 from an external computer (e.g., server) via a network (for example, the Internet, a local area network or wide area network) and respective network adapters or interfaces 836. From the network adapters (or switch port adapters) or interfaces 836 and operating system 828 associated with computing device 300 are loaded into the respective hard drive 830 and network adapter 836. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in FIGS. 1-3 illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for improving thin provisioning storage devices in connection with secure delete operations, comprising:
receiving at a physical storage device a first indicator to write a secure delete pattern to a plurality of physical storage locations;
writing the secure delete pattern to a plurality of allocated physical storage locations based on the received first indicator; and
erasing a plurality of storage device metadata regions based on a second indicator, wherein the metadata regions map the plurality of allocated physical storage locations to a plurality of virtual storage locations.

2. The method of claim 1, wherein writing the secure delete pattern further comprises:
searching the plurality of virtual storage locations for the corresponding physical storage locations, wherein the physical storage locations are allocated; and
writing the secure delete pattern to the physical storage locations based on the physical storage locations being allocated.

3. The method of claim 1, wherein the first indicator includes one or more of:
a field in a control block; or a protocol command in a separate protocol channel (RPC).

4. The method of claim 1, wherein the second indicator includes one or more of:
a field in a control block; or a protocol command in a separate protocol channel (RPC).

5. The method of claim 1, wherein the storage device differentiates the request to write the secure delete pattern from other write requests based on the first indicator.

6. The method of claim 1, wherein erasing the plurality of storage device metadata regions is based on a second indicator signaling an end of the request to write the secure delete pattern.

7. The method of claim 2, further comprising:
bypassing a request to write the secure delete pattern where the virtual storage location does not correspond to the physical storage location that is allocated.

8. A computer program product for improving thin provisioning storage devices in connection with secure delete operations, the computer program product including a device driver program embodied on a computer readable storage medium, the device driver program including code executable by a processor to perform a method comprising:
receiving at a physical storage device a first indicator to write a secure delete pattern to a plurality of physical storage locations;
writing the secure delete pattern to a plurality of allocated physical storage locations based on the received first indicator; and
erasing a plurality of storage device metadata regions based on a second indicator, wherein the metadata regions map the plurality of allocated physical storage locations to a plurality of virtual storage locations.

9. The computer program product of claim 8, wherein writing the secure delete pattern further comprises:
searching the plurality of virtual storage locations for the corresponding physical storage locations, wherein the physical storage locations are allocated; and
writing the secure delete pattern to the physical storage locations based on the physical storage locations being allocated.

10. The computer program product of claim 8, wherein the first indicator includes one or more of:
a field in a control block; or a protocol command in a separate protocol channel (RPC).

11. The computer program product of claim 8, wherein the second indicator includes one or more of:
a field in a control block; or a protocol command in a separate protocol channel (RPC).

12. The computer program product of claim 8, wherein the storage device differentiates the request to write the secure delete pattern from other write requests based on the first indicator.

13. The computer program product of claim 8, wherein erasing the plurality of storage device metadata regions is based on a second indicator signaling an end of the request to write the secure delete pattern.

14. The computer program product of claim 9, further comprising:
bypassing a request to write the secure delete pattern where the virtual storage location does not correspond to the physical storage location that is allocated.

15. A computer system for improving thin provisioning storage devices in connection with secure delete operations, the computer system comprising one or more processors, one or more computer-readable storage devices, and a plurality of program instructions stored on at least one of the one or more storage devices for execution by at least one of the one or more processors, the plurality of program instructions comprising:
program instructions to receive at a physical storage device a first indicator to write a secure delete pattern to a plurality of physical storage locations;
program instructions to write the secure delete pattern to a plurality of allocated physical storage locations based on the received first indicator;
program instructions to differentiate the request to write the secure delete pattern from other write requests based on the first indicator; and
program instructions to erase a plurality of storage device metadata regions based on a second indicator, wherein the metadata regions map the plurality of allocated physical storage locations to a plurality of virtual storage locations.

16. The computer system of claim 15, wherein writing the secure delete pattern further comprises:
searching the plurality of virtual storage locations for the corresponding physical storage locations, wherein the physical storage locations are allocated; and
writing the secure delete pattern to the physical storage locations based on the physical storage locations being allocated.

17. The computer system of claim 15, wherein the first indicator includes one or more of:
a field in a control block; or a protocol command in a separate protocol channel (RPC).

18. The computer system of claim 15, wherein the second indicator includes one or more of:
a field in a control block; or a protocol command in a separate protocol channel (RPC).

19. The computer system of claim 15, wherein erasing the plurality of storage device metadata regions is based on a second indicator signaling an end of the request to write the secure delete pattern.

20. The computer system of claim 16, further comprising:
bypassing a request to write the secure delete pattern where the virtual storage location does not correspond to the physical storage location that is allocated.
